(19) United States
(12) Patent Application Publication
(10) Pub. No.: US 2006/0272163 A1
(43) Pub. Date: Dec. 7, 2006

(54) Fruit cutter

(76) Inventor: Tony Hsu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/145,990

(22) Filed: Jun. 7, 2005

(51) Int. Cl. B26B 3/00

(52) U.S. Cl. 30/316

(57) ABSTRACT

A fruit cutter includes a hollow body with a ring cutter, a push ring, and rib blades. The ring cutter is provided at the bottom of the hollow body. The push ring is provided at the top of the hollow body at a certain angle in relation to the hollow body. The rib blades are formed around the outer wall of the hollow body extending upwardly from the ring cutter to the push ring. Each rib blade is formed in an arc cross-section. By pushing the push ring downwardly, the ring cutter will cut fruit to the size that can fit into the opening of a juice maker. The rib blades will cut the rest portion of the fruit again to decrease press resistance.

### BACKGROUND OF THE INVENTION

1. Field of the Invention

The present invention relates to a fruit cutter, and more particularly, to a fruit cutter to cut fruit to the size that can fit into the opening of a juice maker.

2. Description of the Prior Art

Conventional fruit cutters are designed to peel off the skin of fruit, not to cut them into small pieces. The user has to cut them into small pieces after the skin is peeled off.

### SUMMARY OF THE INVENTION

The primary purpose of the present invention is to provide a fruit cutter, which cuts fruit to the size that can fit into a juice maker.

To achieve the purpose, the present invention comprises a hollow body with a ring cutter, a push ring, and rib blades. The ring cutter is formed underneath the hollow body. The push ring is formed at the top of the hollow body at a certain angle in relation to the hollow body. The rib blades are formed around the outer wall of the hollow body extending upwardly from the ring cutter to the push ring. Each rib blade is formed in an arc cross-section.

### BRIEF DESCRIPTION OF THE DRAWINGS

FIG. 1 is a perspective view of the present invention;

FIG. 2 is a side view of the present invention, and

FIG. 3 is a cross-sectional view showing the operation of the present invention.

### DETAILED DESCRIPTION OF THE PREFERRED EMBODIMENT

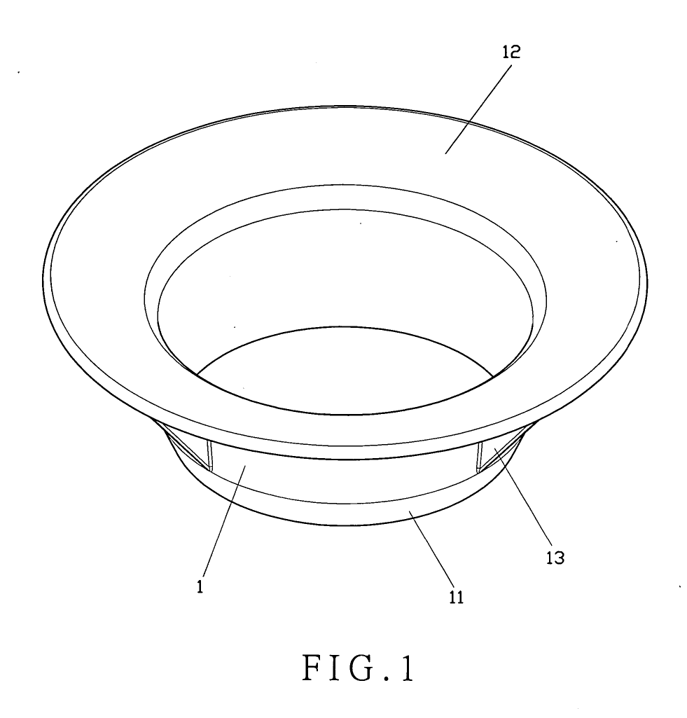

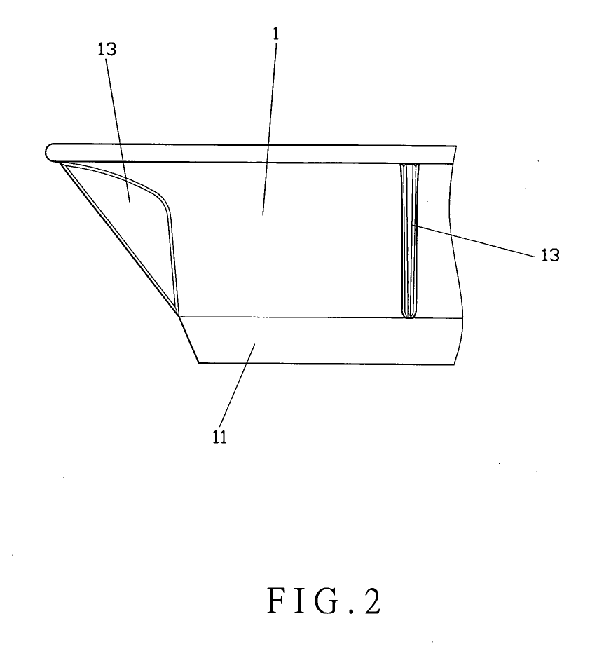

As shown in FIGS. 1 and 2, the preferred embodiment of the present invention comprises a hollow body 1 with a ring cutter 11, a push ring 12 and rib blades 13. The ring cutter 11 is provided at the bottom of the hollow body 1. The push ring 12 is provided at the top of the hollow body 1 at a certain angle in relation to the hollow body 1. The rib blades 13 are formed around the outer wall of the hollow body 1 extending upwardly from the ring cutter 11 to the push ring 12. Each rib blade 13 is formed in an arc cross-section.

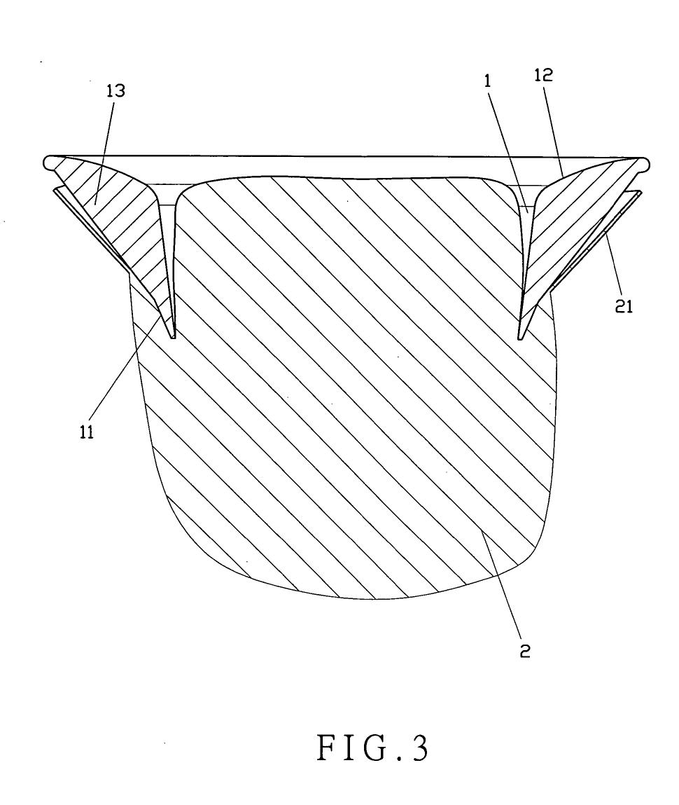

To operate the present invention, as shown in FIG. 3, by pressing the push ring 12, the ring cutter 11 will cut fruit 2 to the size that can fit into the opening of a juice maker, and the rest portion 21 of the fruit 2 will be cut again by the rib blades 13 to decrease press resistance.

I claim:

1. A fruit cutter comprising a hollow body with a ring cutter, a push ring, and rib blades, said ring cutter being provided at a bottom end of said hollow body, said push ring being provided at a top end of said hollow body.

2. The fruit cutter, as recited in claim 1, wherein said push ring is formed at a certain angle in relation to said hollow body.

3. The fruit cutter, as recited in claim 1, wherein said rib blades are formed around an outer wall of said hollow body.

4. The fruit cutter, as recited in claim 1, wherein said rib blades extend upwardly from said ring cutter to said push ring.

5. The fruit cutter, as recited in claim 1, wherein each said rib blade is formed in an arc cross-section.
